(19) United States
(12) Patent Application Publication
(10) Pub. No.: US 2012/0161443 A1
(43) Pub. Date: Jun. 28, 2012

(54) WIND TURBINE

(75) Inventors: George Moser, Brighton, MI (US); Randy W. Linn, Charlotte, MI (US); Van Walworth, Lebanon, TN (US); Craig S. Whitaker, Fairfield, OH (US)

(73) Assignee: ENER2 LLC, Westland, MI (US)

(21) Appl. No.: 13/203,659

(22) PCT Filed: Feb. 8, 2010
(86) PCT No.: PCT/US10/00330

§ 371 Date: Mar. 7, 2012

Related U.S. Application Data
(60) Provisional application No. 61/208,752, filed on Feb. 28, 2009.

(51) Int. Cl. H02P 9/06; F03D 11/02

(52) U.S. Cl. 290/44; 290/55

(57) ABSTRACT

A wind turbine utilizes a rotor assembly rotating about a substantially horizontal shaft, wherein said rotational motion is converted to a substantially vertical rotational motion through a shaft extending down from the nacelle located near the top of the tower structure to a mechanical room located at a lower altitude relative to the top of the tower. Said lower mechanical room houses some of the large heavy operational components of the turbine such that the turbine is not as top heavy as conventional turbines, and maintenance of the turbine is improved through ease of access to the lower altitude mechanical room.

### CROSS-REFERENCE TO RELATED APPLICATIONS

This application claims priority to U.S. Provisional Patent Application No. 61/208,752, filed Feb. 28, 2009, which is hereby incorporated by reference and made a part hereof.

### FEDERALLY SPONSORED RESEARCH OR DEVELOPMENT

Not Applicable.

### TECHNICAL FIELD

The subject invention is related to the industry of alternative energy production and more specifically the industry of wind turbines.

### BACKGROUND OF THE INVENTION

Wind turbines are well known mechanical devices used for hundreds of years to perform various mechanical works. The application and use of wind turbines to generate electricity was a natural and obvious application of turbines as soon the need for and availability of electricity was developed. Since the initial uses of turbines for generating electric power first appeared, many improvements and efficiencies have been applied to turbine technology.

Traditional turbines have at least one rotor blade mounted on a hub rotating about a horizontal axis. The turbine unit is usually fixed to the top of a tower structure and is capable of being rotated about the axis of the tower (yaw) in order to align with the direction of the wind. Most modern wind turbines of the current state of the art employ three rotor blades.

The ever increasing need for energy, combined with environmental concerns for alternative energy systems, provides the catalyst for more development and investment in wind power technology than ever before in the history of wind turbines.

Many governments of countries and states have put legislative policies in place regarding renewable power generation such as wind power. There are many countries that want to increase renewable energy generation from 5% of the total power produced to 10%, 20% or even more. Scotland has announced plans for 50% energy from wind. The USA is considering a 20% target energy production from alternative energy. As a result, there is massive demand worldwide for wind turbines. Turbine manufacturers have had great difficulty meeting the demand for turbine units in recent years. Traditionally many new turbine unit orders are booked years in advance and/or backlogged.

One major issue in the wind industry is the high cost and complexity of some major components, especially transmissions. Transmissions have to be designed for a high ratio (about 1:100) and very high torque, and at the same time they have to be designed for low weight and size, because they are installed on top a high, top-heavy towers. Generators and other components suffer from the same problems.

Another major issue is the difficulty and cost of maintenance when the components and devices to be maintained are located 100 meters or higher over ground level, with difficult, dangerous and expensive access.

The subject invention addresses the above issues by removing the heavy components (transmission, generator, azimuth motors, etc.) from the nacelle and relocating them at or near the bottom of the tower. This has been attempted before, but it has never been successfully done, because the wrong technologies were used and some critical issues, especially related to the long vertical shaft(s) required. The subject invention resolves those key critical issues and provides a very innovative, lower weight and lower cost solution for modern wind turbines.

The subject invention addresses the concerns and limitations described in the prior art and provides major contributions and improvements in that regard.

### SUMMARY OF THE INVENTION

One problem with prior art turbines is that the heavy nacelle causes the turbine to effectively be “top heavy” with the nacelle perched on top of the tower. A top heavy tower requires a very strong structure in order to be able to recover from the sway induced from the wind or other forces. A top heavy structure also has a tendency to vibrate and oscillate, which requires expensive reinforcement of the tower. This condition forces the design and cost of the tower build to be extremely high.

The subject invention addresses this problem by providing a turbine wherein the generator and transmission and other components of the operation are located at a lower altitude relative to the top of the tower or even ground level. As a result of the subject invention, the tower is not as top heavy as conventional turbines and can be built more economically.

Another problem with conventional turbines is that maintenance on the operating components is very difficult because they are located at the top of the tower. As a result access is limited and the types of maintenance are limited due to limited access through the inside of the tower. Needless to say, the replacement of an operating component in the nacelle is very difficult without establishing similar erecting equipment at the site that it originally required to assemble the turbine in the first place. This process is both expensive and time consuming and as result downtime for the turbine is unnecessarily increased before replacement components can be installed. The subject invention addresses this problem by locating some of the operating components at a lower altitude relative to the top of the tower so that replacement and/or overhaul of the components are much less expensive and easily accessed. As a result, downtime due to maintenance is reduced which results in more energy production uptime.

The preferred embodiment of the subject invention includes a tower with a slim cross-section shaped like an airfoil, which is actually ideal to minimize the obstacle to airflow and the disruption of the airflow behind the rotor, thereby minimizing the force fluctuations on the blades as they sweep close to the tower in their rotation. That has a positive effect on both power production and on reducing stress on the blades. It also reduces turbulence behind the tower (which can affect neighboring turbines) allowing other turbines to be placed closer to each other, with better land utilization.

The airfoil shape of this novel tower is also ideal for weight reduction of the tower (over and above the already achieved reductions in weight by relocating heavy components to the bottom of the tower), because a substantial portion of the tower now is yawed from its bottom to always face the wind, and the airfoil shape is especially strong when oriented in a direction parallel to the wind, which will always be the normal operating position. To a significant extent the tower will also be self-yawing, because the wind will tend to automatically align it in a direction parallel to the wind. A motorized yawing mechanism is also provided near the bottom of the tower to assist in yawing when the wind force is not enough, or to turn the tower in a different direction for service.

The airfoil shape will allow a significant weight and cost reduction because of a more efficient shape from an engineering point of view. The stresses in a beam (and a tower is basically a long beam subjected to wind forces) are inversely proportional to the moment of inertia of the cross-section. The moment of inertia is proportional to the fourth power of the maximum dimension of the cross-section opposing the forces. In other words, if the maximum dimension using an elongated shape rather than a circular shape can be increased by just 50%, then the stresses can be reduced by a factor of 5 (1.5 raised to 4). Therefore an elongated beam becomes 5 times stronger by orienting it correctly. This is the reason why a flat beam can be easily bent in the flat direction, but it can be almost impossible to bend it in a perpendicular direction. This invention takes advantage of that effect to achieve a slimmer, more installation-friendly and calibration-friendly, lighter and more cost-effective tower.

The airfoil section is also ideal for the installation and calibration of the vertical shaft, because the vertical shaft can be located in the narrower section of the tower, which is advantageous for the location of the shaft bearings and bearing supports, while the wider section of the tower can be used for an elevator, which is useful for shaft calibration, monitoring and service, as well as for cables and other accessories.

Another important issue addressed by this invention is the cut-in wind speed. In an effort to increase power output from wind, the industry has been dramatically increasing rotor size, and concurrently, the size and weight of all driveline components in the nacelle. As a result, the wind cut-in speed (the minimum wind velocity needed to start rotation of the turbine) has been going up. In many areas with low winds there are extended periods of time where the wind turbines are sitting idle. This invention provides an auxiliary electric motor that is used as a starter motor to start rotation of the turbine with external power (such as power from the grid or any other source of power) when the wind is too low to start rotation. As soon as the inertial forces are overcome and the lubricants start flowing and slightly warming up (a significant factor in cold locations) the auxiliary motor can be turned off and the wind takes over. That can allow many turbines to start producing under conditions where otherwise they would be just standing by, waiting for more favorable winds. A one-way clutch system can be used to ensure automatic decoupling of the auxiliary motor as soon as the wind can take over, at which point the auxiliary motor can be turned off. Of course the generator itself can be designed so that it can also function as a motor and thus build the starter motor function into the generator, if that is more cost-effective than having a separate auxiliary motor. The auxiliary motor would also require a transmission to reduce speed to the low-speed, high-torque condition needed for starting the rotor. Said transmission can be either a separate auxiliary transmission (for occasional use), or the main transmission at the bottom of the tower.

A significant advantage of the starter motor is that it can also be used to calibrate the shaft and make sure that misalignments or other problems can be easily corrected. The calibration personnel can travel up and down the tower in a service elevator, which can be stopped at any point to inspect and calibrate the shaft. The starter motor can be started remotely by the service personnel in the elevator, allowing them to calibrate, make adjustments and test the result immediately. This will be extremely valuable in achieving and maintaining a vertical shaft in good operating condition, without harmful vibrations and oscillations.

An electronic shaft monitoring system (SMS) with permanently installed sensors at frequent positions along the shaft will also be very valuable in detection and rectification of any problems. This system can be monitored by computer and can be accessed at the machine house at the bottom of the tower or even remotely through a telephone line or wireless system.

Other advantages and features of the subject invention will be apparent to those skilled in the art.

### BRIEF DESCRIPTION OF THE DRAWINGS

To understand the present invention, it will now be described by way of example, with reference to the accompanying drawings in which:

FIG. 1 is a front view of a conventional prior art turbine;

FIG. 2 is a side view of the turbine of FIG. 1;

FIG. 3 is a partial blown up view of the turbine of FIG. 1;

FIG. 4 is a side view of one embodiment of the invention;

FIG. 5 is a side view of another embodiment of the invention;

FIG. 6 is a side view of another embodiment of the invention;

FIG. 7 is a partial blown up view of the top of the tower of FIG. 6;

FIG. 8 is a partial blown up view of another embodiment of the top of the tower of FIG. 6;

FIG. 9 is a partial blown up view of another embodiment of the top of the tower of FIG. 6;

FIG. 10 is a side view of another embodiment of the invention;

FIG. 11 is a side view of a shaft for a tower;

FIG. 12 is a side view of a shaft for a tower;

FIG. 12a is an enlarged view of the joint in FIG. 12;

FIG. 13 is a side view of another embodiment of the invention, such as an offshore embodiment;

FIG. 14 is a side view of another embodiment of the invention, such as an offshore embodiment;

FIG. 15 is a schematic of an assembly method for a turbine;

FIG. 16 is another schematic of an assembly method for a turbine;

FIG. 17 is a side view of another embodiment of the invention;

FIG. 18 is an enlarged view of the top of the tower of FIG. 17;

FIG. 19 is an enlarged view of FIG. 18;

FIG. 20 is an enlarged view of the bottom of the tower of FIG. 17;

FIG. 21 is an enlarged view of FIG. 20;

FIG. 22 is two cross sections of a tower;

FIG. 23 is a schematic of wind streams about a tower; and,

FIG. 24 is a schematic of wind streams about another tower.

### DETAILED DESCRIPTION

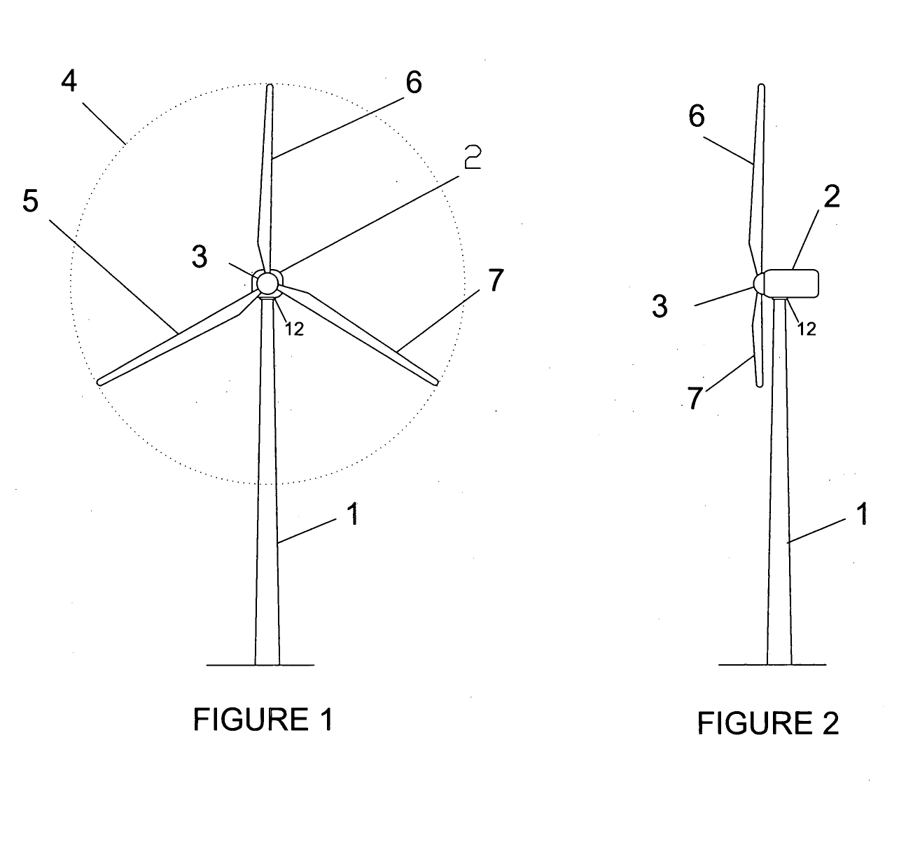

FIG. 1 shows a front view of a conventional prior art turbine. Generically, 4 is a schematic representation of the sweep area of the three rotor blades 5, 6 and 7, which are arrayed around hub 3. The nacelle 2 is the machine house, which contains the hub, transmission, generator, yaw motor, anemometer, mechanical brake, main drive shaft, yaw bearing, controller, wind vane, rotor hub, rotor blade pitch mechanism, and other components, all mounted on tower mast 1.

Modern turbines work when the rotor blades respond to passing wind streams causing the turbine to rotate. The blades can be rotated around their longitudinal axis using a blade pitch mechanism located in the hub to optimize their angle with respect to the wind.

The entire nacelle and rotor is turned to face into the wind to further take advantage of wind speed using a yaw mechanism. The yaw mechanism 12 usually includes a system of gears and electric motors (the so-called yaw or azimuth motors) which cause the nacelle to rotate around the tower. A controller monitors the wind direction and a host of other parameters and initiates the yaw mechanism as needed to keep the rotor facing into the wind.

As the rotor blades sweep through the air, they turn a central shaft in the nacelle which is connected to a gear box. The gear box is connected to the generator to produce electric power. A shaft between the generator and the gearbox includes a brake mechanism which is used to stop the rotor from turning and/or to slow it down to maintain a certain speed.

FIG. 2 shows a side view of the same conventional prior art as shown in FIG. 1.

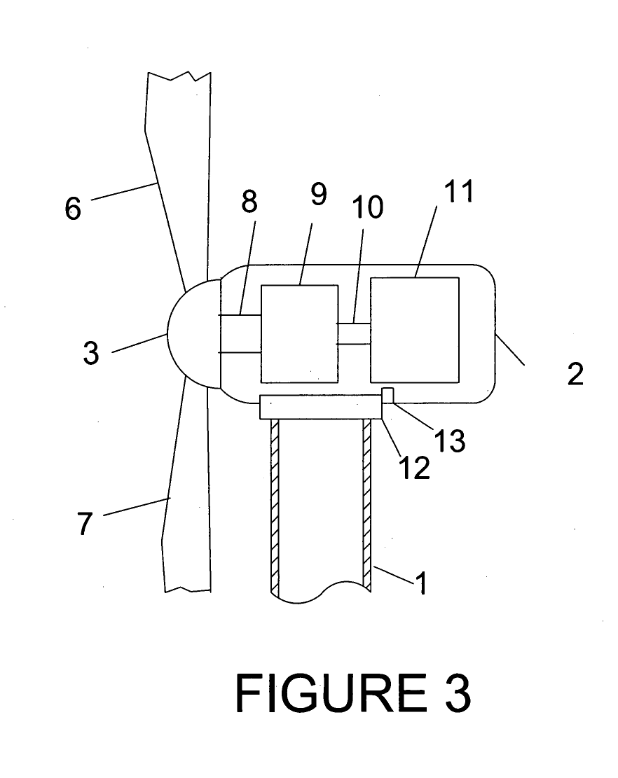

FIG. 3 shows tower 1 the nacelle 2 or machine house mounted on top thereof, with a schematic representation of its internal components. Rotor blades 6 and 7 sweep through the air connected at the root of the blade at the hub 3. The rotational motion turns a shaft 8 in the nacelle 2 which is connected to gearbox 9. Gearbox 9 is connected to generator 11 by a second shaft 10 to produce electric power. Some types of generators, typically called direct-drive generators, eliminate the need for a gear box. In such a case (not shown in this Figure) the slow shaft 8 would connect directly with the direct-drive generator. Yaw mechanism 12 is motorized by yaw motor 13.

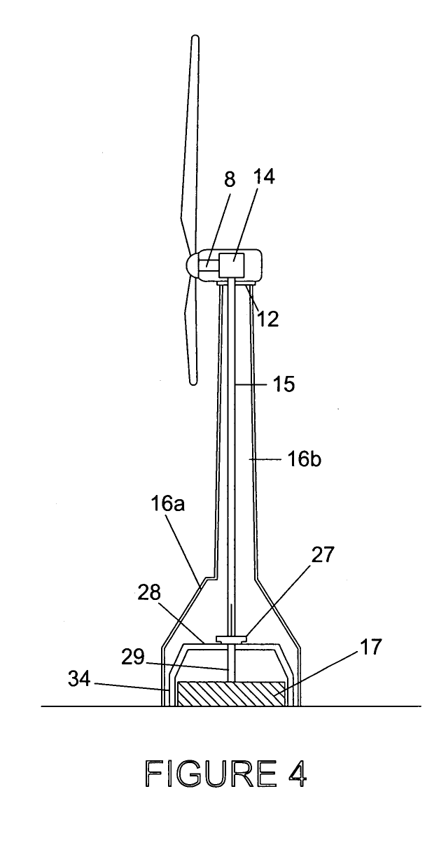

FIG. 4 shows a first embodiment of the subject invention. The rotor (of which two of the 3 blades are shown) is connected via a horizontal shaft 8 to gear box 14. Gear box 14 converts horizontal axis rotation from the rotors to a vertical axis rotation for a downward extending shaft 15. Shaft 15 extends downward to thrust bearing 27. 12 is the yaw mechanism. In this embodiment, the yawing mechanism is shown at the top of the tower similar to conventional turbines. The tower cross-section is conventionally round in shape and only the nacelle turns during yaw adjustments. Thrust bearing 27 is supported by a mezzanine support system depicted by platform 28 and support members 34. Lower connecting shaft 29 links shaft 15 through thrust bearing 27 to direct drive generator 17. Lower tower housing 16a enlarges near the base of the tower to enclose the operating components located inside. Direct-drive generators are one method of converting rotational shaft torque into electricity. Upper tower portion 16b is supported by lower tower portion 16a and/or other internal structural supports.

Gear box 14 might convert horizontal rotation to vertical rotation with a ratio of 1:1 for some applications, while other applications the conversion might be as high as 1:10 or more, wherein the vertical shaft is rotating many times faster than the horizontal shaft. It is envisioned that a typical embodiment of the subject invention benefits favorably from a 1:3 ratio wherein the vertical output shaft is rotating three times faster than the horizontal shaft.

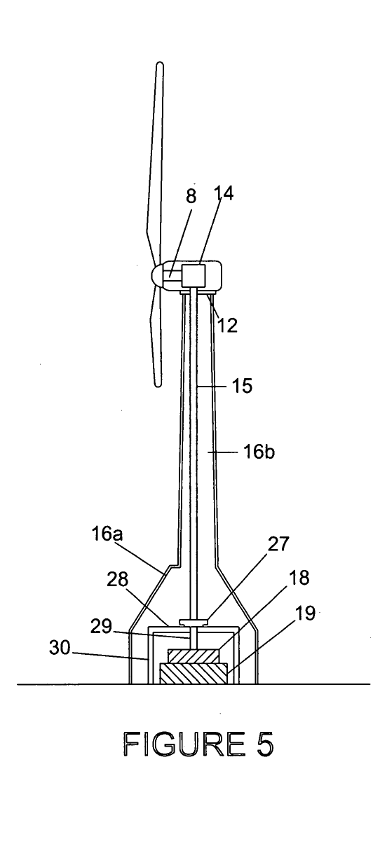

FIG. 5 shows a second embodiment of the subject invention. The rotor (of which two of the 3 blades are shown) is connected via a horizontal shaft 8 to gear box 14. Gear box 14 converts horizontal axis rotation from the rotors to a vertical axis rotation for a downward extending shaft 15. Shaft 15 extends downward through yaw mechanism 12 to thrust bearing 27. Thrust bearing 27 is supported by a mezzanine support system depicted by platform 28 and support members 30. Lower connecting shaft 29 links shaft 15 through thrust bearing 27 to transmission 18. The transmission is designed to increase rotational mechanical advantage from vertical shaft 15. It is envisioned that in one embodiment of the subject invention transmission 18 would increase rotation by a ratio of 1:30. Transmission 18 is connected to generator 19 for the production of electrical power. Combination transmission-generator sets can be more cost effective to manufacture and require less room than direct-drive generators. Tower housing 16a enlarges near the base of the tower to enclose the operating components located inside.

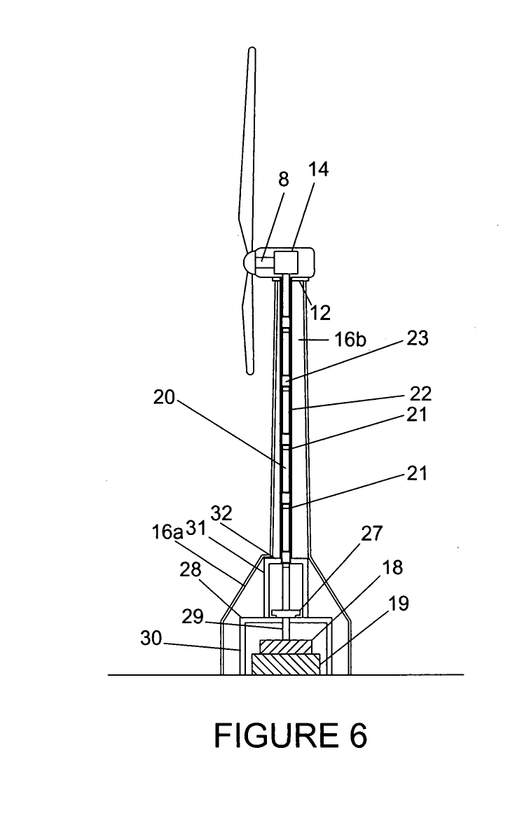

FIG. 6 shows a third embodiment of the subject invention. The rotor (of which two of the 3 blades are shown) is connected via a horizontal shaft 8 to gear box 14. Gear box 14 converts horizontal axis rotation from the rotors to a vertical axis rotation for a downward extending shaft 20. Shaft 20 extends downward through yaw mechanism 12 to thrust bearing 27. Thrust bearing 27 is supported by a mezzanine support system depicted by platform 28 and support members 30. Lower connecting shaft 29 links shaft 20 through thrust bearing 27 to transmission 18. Transmission 18 is connected to generator 19 for the production of electrical power. In order to prevent warping or misalignment of shaft 20 sleeve 22 surrounds the shaft. Sleeve 22 is supported independently from shaft 20 by a second mezzanine support structure depicted by platform 32 and support members 31. Shaft 20 is constructed from at least two lengths and joined at joint 21. Taller towers will likely employ multiple shaft lengths 20 joined at respective joint(s) 21. Journal or bearing 23 is provided frequently along the length of shaft 20 to provide a wear surface or rotational bearing means between shaft 20 and the inside of sleeve 22. Journal 23 makes contact with the inside surface of sleeve 22 to guide shaft 20 and maintain alignment.

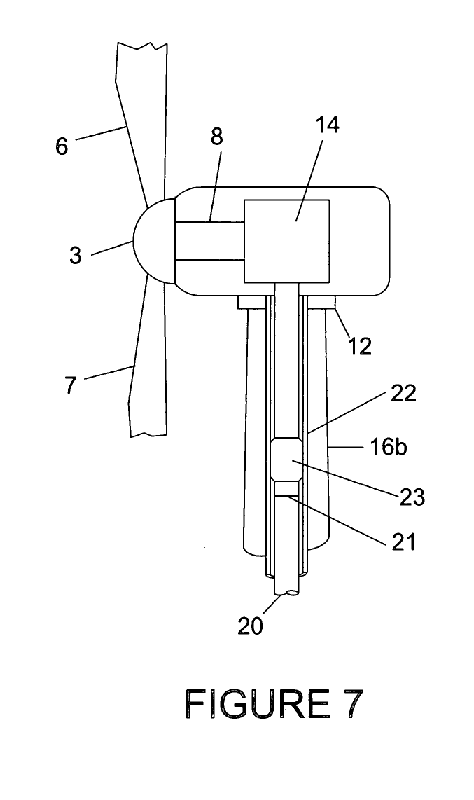

FIG. 7 shows an enlarged view of the top of the tower shown in FIG. 6.

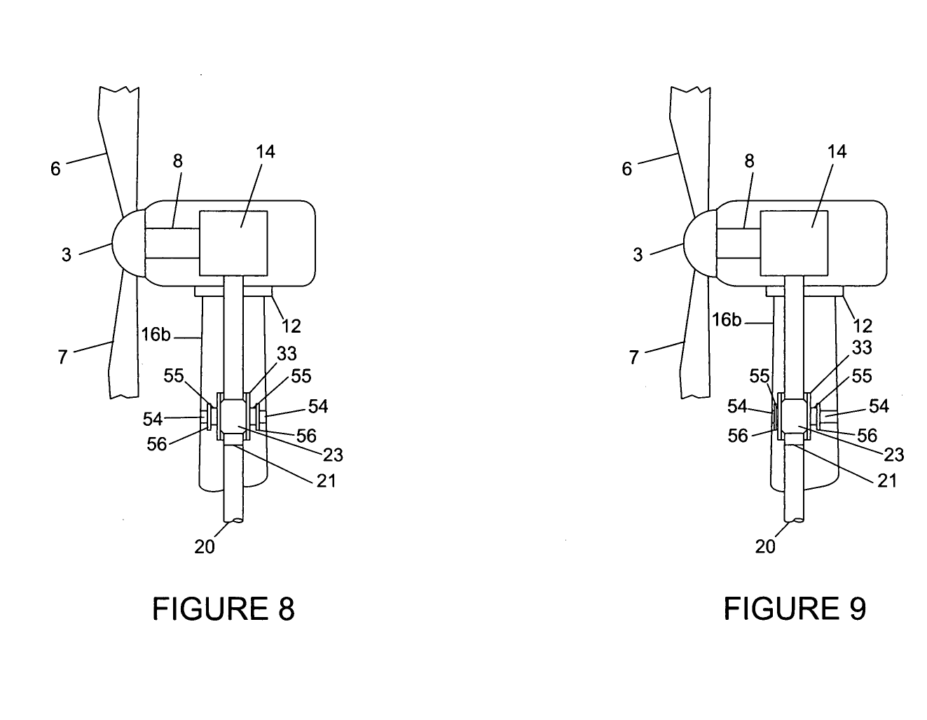

FIG. 8 shows another embodiment of the subject invention similar to that shown in FIG. 7. The rotor (of which two of the 3 blades are shown) is connected via a horizontal shaft 8 to gear box 14. Gear box 14 converts horizontal axis rotation from the rotors to a vertical axis rotation for a downward extending shaft 20. Shaft 20 extends downward through yaw mechanism 12. Lengths of shaft 20 are joined as necessary at joint 21. In order to prevent warping or misalignment of shaft 20 steady-rest 33 surrounds the shaft at frequent intervals. Steady rest 33 is supported independently from shaft 20. If steady rest 33 needs to be adjusted or shifted laterally to align with shaft 20, support members 54 and 55 translate laterally relative to each other by turning adjustment member 56. In addition to lateral support adjustments, adjustment members also provide axial adjustment if needed so that steady rest 33 properly aligns axially with shaft 20. Journal 23 provides a wear and/or bearing guide for shaft 20 as it rotates in contact with the inside diameter surface of steady rest 33. Support members 54, 55, and 56 allow ample open space to allow passage up and/or down past the support members for maintenance and service of the turbine.

FIG. 9 is basically the same view as FIG. 8, except that shaft 20 is located off-center to the axis of the tower. If steady rest 33 needs to be adjusted or shifted laterally to align with shaft 20, support members 54 and 55 translate laterally relative to each other by turning adjustment member 56. In addition to lateral support adjustments, adjustment members also provide axial adjustment if needed so that steady rest 33 properly aligns axially with shaft 20. Journal 23 provides a wear and/or bearing guide for shaft 20 as it rotates in contact with the inside diameter surface of steady rest 33. Support members 54, 55, and 56 allow ample open space to allow passage up and/or down past the support members for maintenance and service of the turbine. The off-set location of shaft 20 provides improved access room inside the tower structure for personnel and/or other operational cables, communications, ladders, equipment hoists, etcetera.

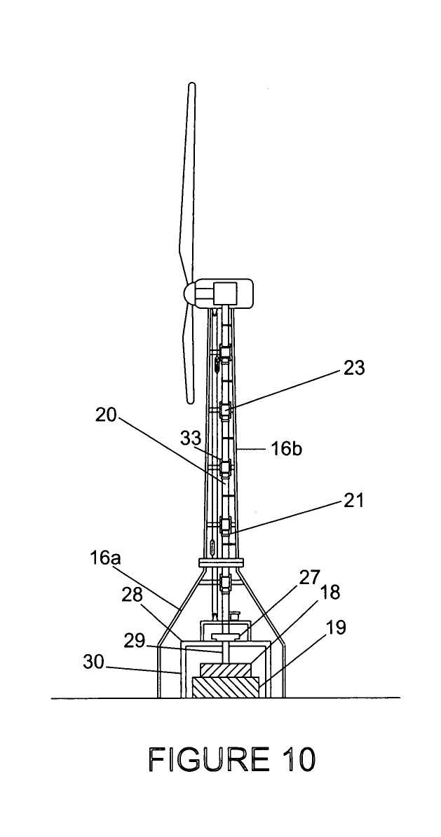

FIG. 10 shows an embodiment of the subject invention including the lower tower portion 16a and an upper tower portion 16b. Lengths of shaft 20 extend from the top of the tower to thrust bearing 27. In order to prevent warping or misalignment of shaft 20 steady-rest 33 surrounds the shaft at frequent intervals. Journal 23 provides a wear and/or bearing guide for shaft 20 as it rotates in contact with the inside surface of the steady rest 33. Thrust bearing 27 is supported by a mezzanine support system depicted by platform 28 and support members 30. Lower connecting shaft 29 links shaft 20 through thrust bearing 27 to transmission 18. Transmission 18 is connected to generator 19 for the production of electrical power. Shaft 20 is positioned off-center relative to the axis of the tower.

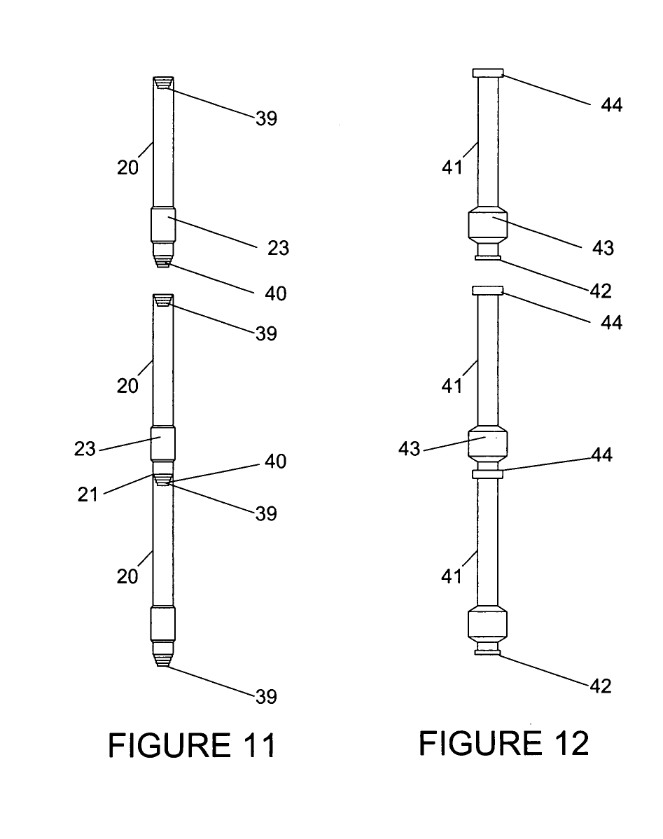

FIG. 11 shows one embodiment of two lengths of shaft 20 joined at joint 21. Those skilled in the art will readily appreciate that there are numerous well-accepted methods to connect sections of shafts together. This schematic merely calls attention to the fact it is practical that multiple lengths of shaft will require appropriate joining. FIG. 11 shows a male end 40 on one end of shaft length 20 and female end 39 at the other end of each shaft length.

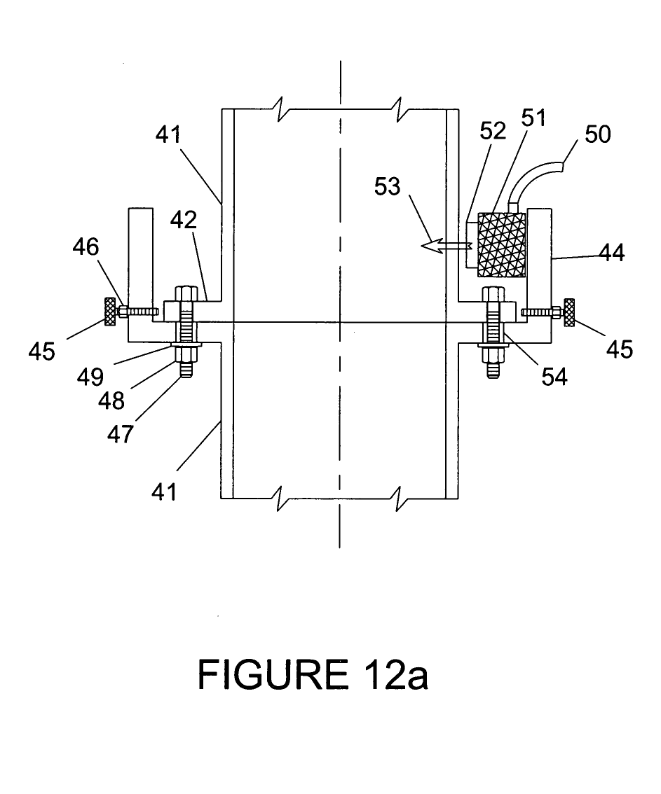

FIG. 12 shows an alternate embodiment to join two lengths of shaft 41 together. Small flange 42 is designed to insert relatively centered into large shroud flange 44 and bolted together. Journal 43 will guide the shaft assembly inside steady rest providing a contacting surface to minimize noise and misalignment. The outside diameter of Journal 43 is larger that the outside diameter of shroud flange 44 to prevent the flange from contacting anything in the tower as it rotates.

FIG. 12a shows an enlarged view of the flange joint depicted in FIG. 12. Two lengths of shaft 41 are joined when shroud flange 44 and small flange 42 mate together face to face. Lateral adjustment screw 45 provides lateral adjustment to shift the flanges laterally relative to each other to better align the shaft assembly. After lateral adjustment is completed, lateral adjustment locking jam nut 46 is tightened.

Maintenance personnel are easily able to make lateral adjustments to the shaft by attaching a temporary portable motor drive to the shaft assembly to provide temporary rotation for alignment inspection. Shaft rotation can also be provided using a starter motor installed next to the shaft. The shaft rotation motor also provides a dual purpose as a starter motor to initiate rotor cut-in rotation. As the shaft gently rotates via a motor, maintenance personnel are able to identify flanges where minor alignment adjustments are required to fine-tune alignment. Misalignment can be found with common laser devices, various precision measurement methods, or the use of an installed shaft alignment sensor system. At any flange location on the shaft assembly, and/or at any point 360° around the shaft, maintenance personnel are able to position a hydraulic cylinder 51 inside the shroud flange. With the bolts 47 loosened and lateral adjustment screws 45 backed out, hydraulic fluid is applied to cylinder 51 through hose 50 causing ram 52 to push shaft section in the lateral direction of arrow 53. After adjustment is made, portable cylinder 51 is removed and bolts 47 are tightened with nuts 48 and washer 49. Lateral adjustment screw 45 and jam nut 46 are tightened to prevent any lateral slippage between flanges during operation of the turbine. Bolt hole 54 is oversized to allow for lateral adjustments.

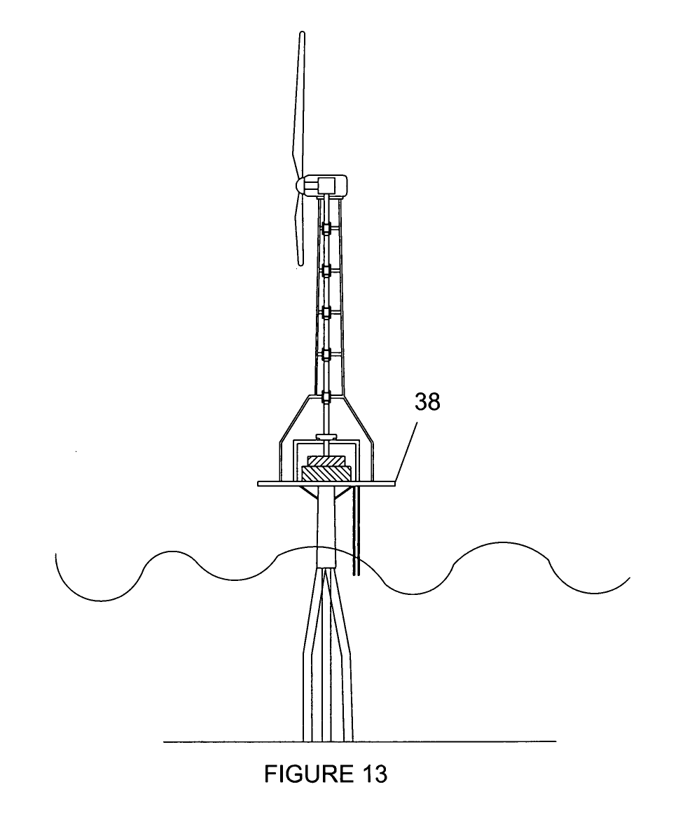

FIG. 13 is another embodiment of the subject invention showing an off-shore installation. A platform 38 is used for access and maintenance. The wavy line is the sea-level. The tower is mounted on a base like a tripod for stability. Of course other mounting systems can be used, like a single pylon, two legs, four legs, etc. Platform 38 is sufficient to support the entire tower structure including sufficient space for the operational components located inside the housing base of the tower. An installation such as this makes it possible for economical maintenance and/or replacement of the generator and other components in the platform housing without reestablishing the expensive equipment required to erect the turbine in the first place.

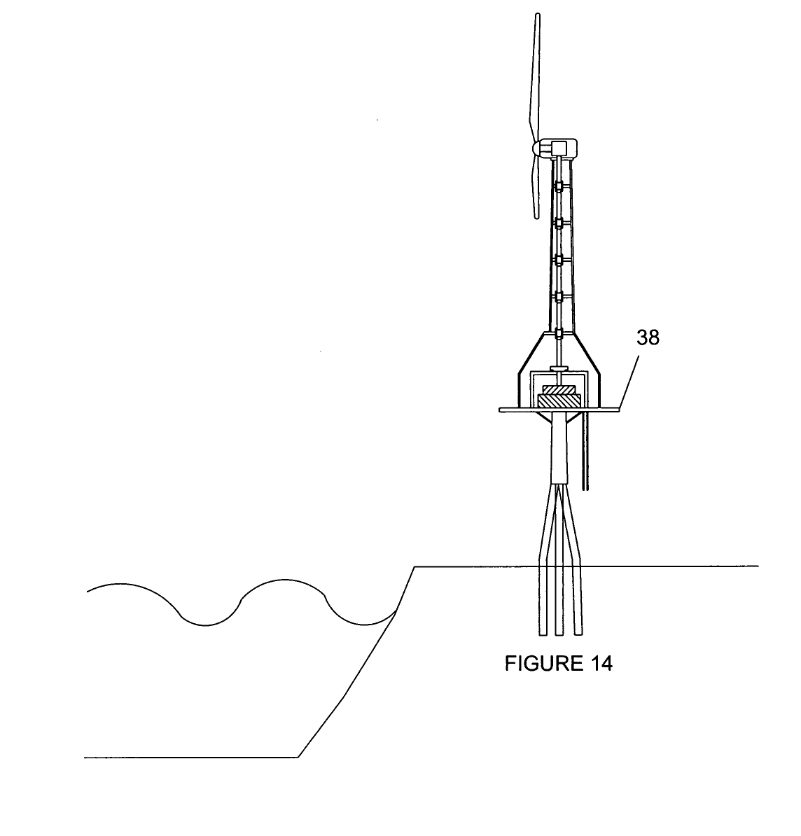

FIG. 14 shows an embodiment of the subject invention on land with an elevated platform 38 suitable to support the entire tower structure. This type of installation is desirable for locations prone to flooding conditions and/or shore lines located in areas prone to suffer from storm surges and/or other tidal flooding because the platform 38 and the entire operating components of the turbine can be located above known flood planes and yet remain close enough to the ground to affect relatively inexpensive maintenance and service for the turbine.

This type of installation also provides a reduced foot print on the ground which in some locations may be required to nestle the foundational supports into a relatively small area allowing the platform 38 to cantilever out over the foundational supports.

Another advantage of this type of installation is that it provides an increased measure of security for the turbine in areas where security issues are a prevalent concern. Access to the platform and subsequently the operations of the turbine can be easily restricted and secured predominately by taking advantage of the elevated platform 38.

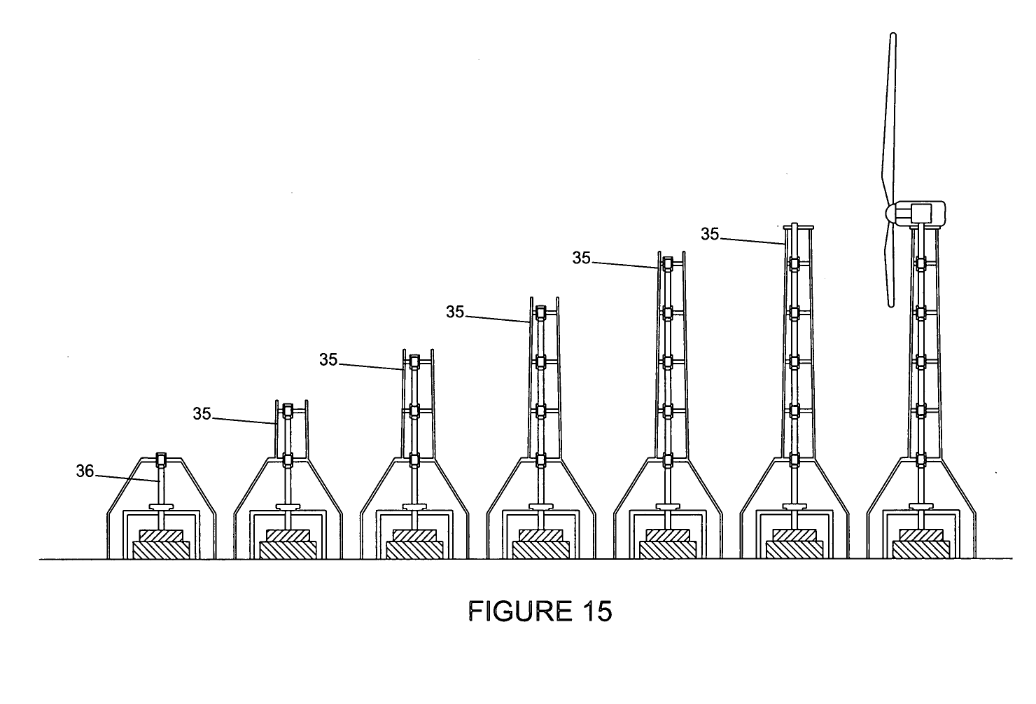

FIG. 15 shows an assembly method for one embodiment of the subject invention in which the base of the tower is constructed first. Initial shaft length 36 is installed in the base housing. Next, as each section 35 of the tower is assembled, a corresponding length of shaft 36 is assembled on the previous length. This process continues until the entire tower is assembled along with the corresponding lengths of shaft.

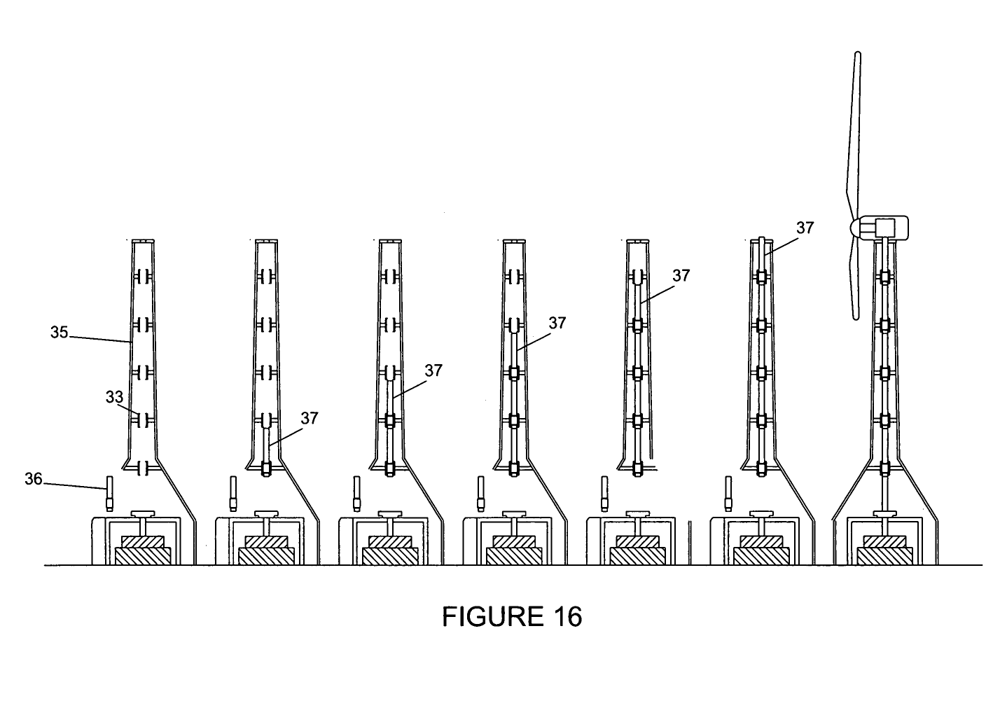

FIG. 16 shows another assembly method for one embodiment of the subject invention in which the entire tower 35 is assembled by normal means including shaft support members 33. One shaft length 36 is positioned in the tower base through an opening in the housing of the tower base and installed. Next, the initial shaft length 36 is raised up to position 37 to make room for a second shaft length 36. This process continues until all of the shaft lengths 36 have been assembled together. This assembly method provides a further advantage whereby the entire shaft can be disassembled by reversing the assembly process. This is very advantageous for maintenance purposes related to the shaft because the entire tower does not have to be dismantled to gain access to the shaft.

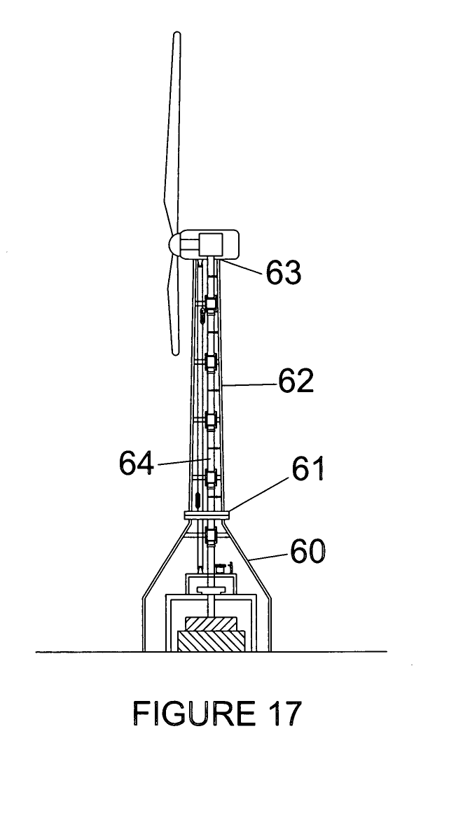

FIG. 17 shows a preferred embodiment of the turbine in shaft 64 is located off-center relative to upper tower portion 62. Yawing mechanism 61 is located at the top of the lower tower portion 60. Since yawing mechanism 61 is located below the rotor sweep, the upper tower portion 62 is rotated about its axis during the yaw function. The nacelle at the top of tower 62 is fixed in position at tower-nacelle connection 63.

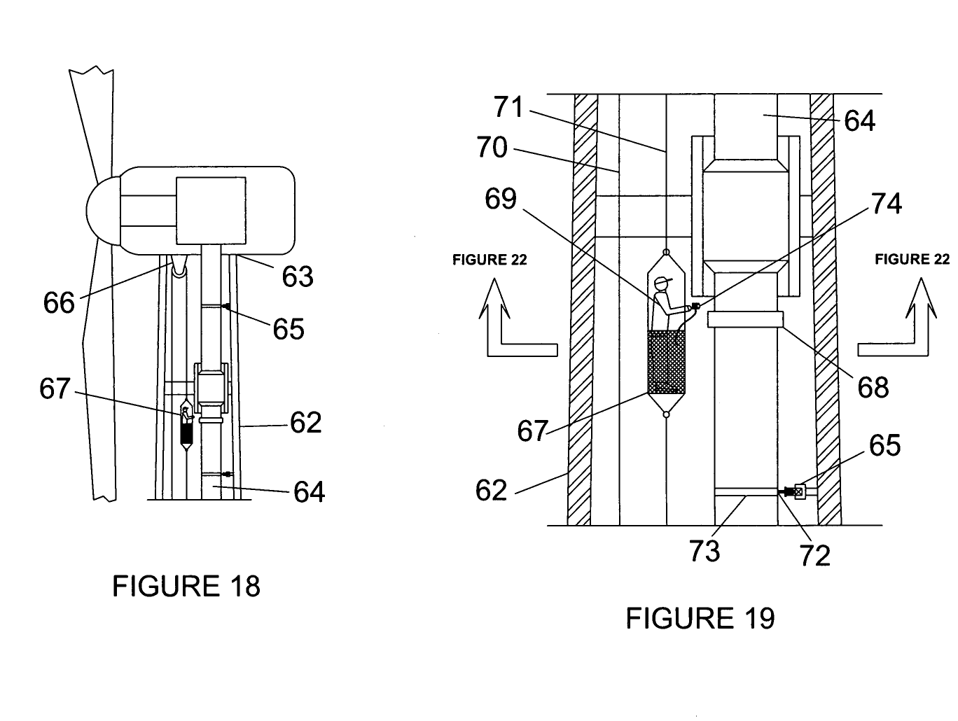

FIG. 18 shows a close-up of FIG. 17 at the top of the tower 62. Nacelle-tower connection 63 is rigid and do not move relative to each other. Shaft 64 is off-set in the tower which provides ample room for service personnel to perform maintenance using a service elevator 67 which is supported and moved using a motorized pulley system 66. Those skilled in the art will appreciate that there are many different types of elevators and/or service mechanisms that can be utilized inside the tower structure.

Shaft Monitoring Sensor (SMS) 65 is permanently mounted near the shaft 64 and duplicates of the SMS are frequently spaced along the length of the shaft to monitor rotation and alignment. The SMS units can be a laser system, proximity sensor, spring loaded wheel or finger stylus, or any one of many different types of sensing devices. The appropriate sensor may be of the contact or non-contact variety. In any case, the sensor is connected to the controller so as to monitor the alignment of the shaft so that appropriate alerts for maintenance can be made as may be required.

FIG. 19 shows a close-up of FIG. 18, wherein maintenance personnel 69 ride in an elevator 67 which is hoisted and supported by cables 70 and 71. Elevator 67 is shown at an appropriate position for the maintenance personnel to place portable hydraulic ram 74 inside of shroud flange 68 to perform alignment adjustments to the shaft. SMS sensor 65 will be used to detect misalignment of the shaft using contact or non-contact portion 72 monitoring precision surface 73. Precision surface 73 is a 360° surface around the shaft and can be a surface machined on the shaft, applied to the shaft, or a precision component affixed to the shaft.

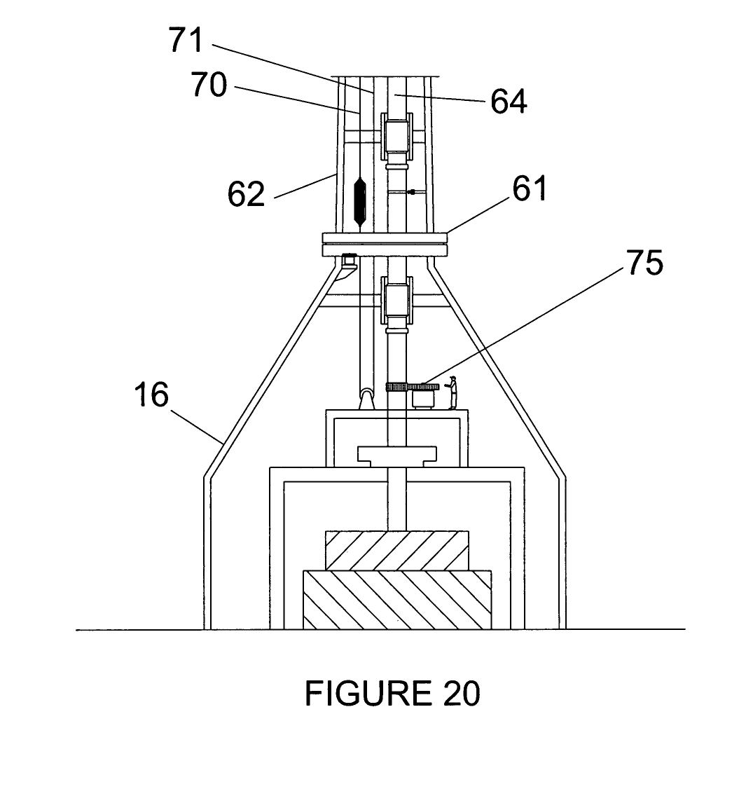

FIG. 20 is a close-up of FIG. 17 focused on the lower portion of the tower structure. Lower tower portion 16 and upper tower portion 62 are joined together at yawing mechanism 61. Starter motor 75 is shown in place to turn shaft 64 for SMS activity and/or for rotor cut-in rotation.

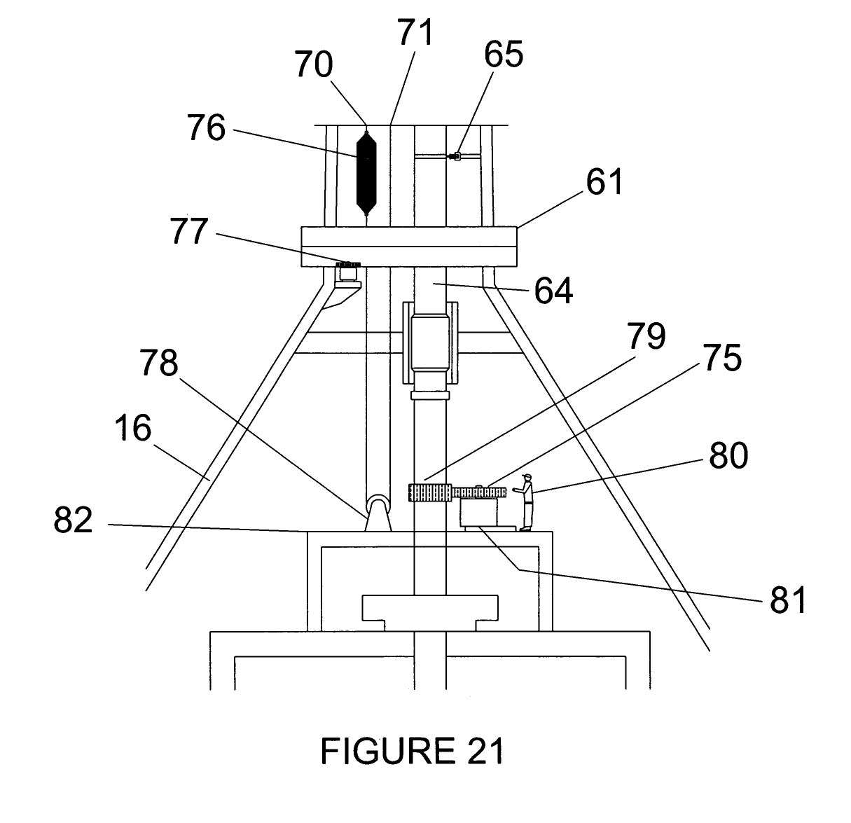

FIG. 21 shows a close-up of FIG. 20 focusing on some of the lower internal operating components at the lower end of shaft 64. Service elevator cables 70 and 71 pass through pulley 78 which is secured on lower support structure 82. Elevator counter weight 76 provides balance and stability to elevator. Yaw mechanism 61 is actuated by yaw motor 71. Starter motor 75 turns mating component 79 which rotates shaft 64. Motor 75 is capable of being engaged and disengaged from mating component 79 as necessary by maintenance personnel 80 by moving motor 75 along rails 81.

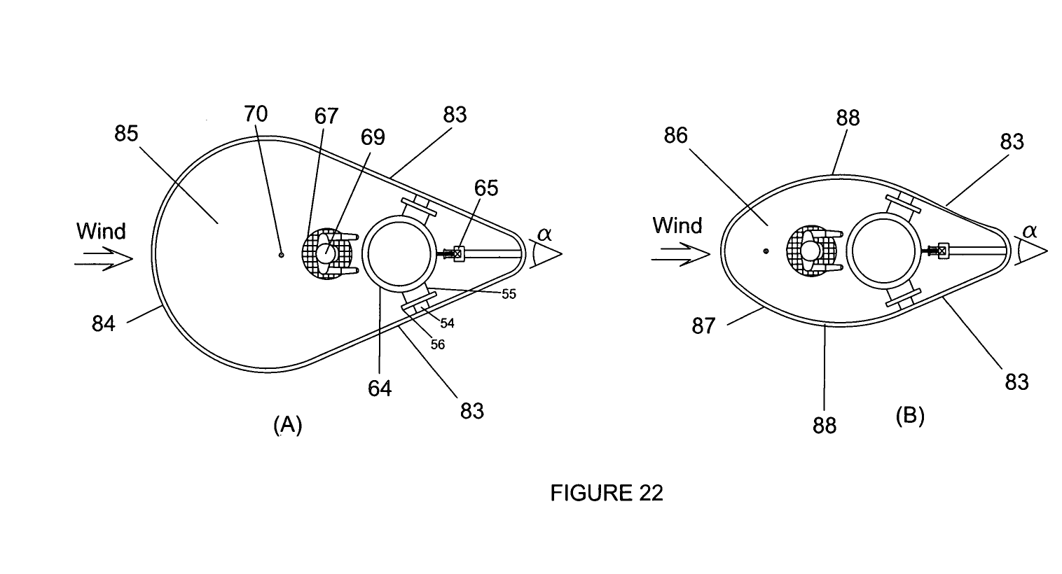

FIG. 22 shows two embodiments (A) and (B) of the subject invention which represent a cross-section of the upper tower. Tower cross-section (A) is basically a tear-drop shape formed by side-wall portions 83 which form angle □ between them. Enclosing the divergent side-wall portions 83 is circular portion 84. The section details include a plan view of the tower cross-section showing the offset location of shaft 64 braced by support system 54, 55, and 56. SMS 65 is shown in position to monitor the shaft. Open space 85 is provided opposite the shaft location. Maintenance personnel 69 rides in elevator 67 which is hoisted by elevator cable 70. The tear-drop shape is turned by the yaw and/or self-oriented by the wind such that the circular portion 84 is confronting the wind.

Tower cross-section (B) is basically a modified symmetrical airfoil shape formed by side-wall portions 83 which form angle □ between them. Transition arcs 88 provide a slim airfoil shape between divergent side-wall portions 83 and circular portion 87. The airfoil shape is turned by the yaw and/or self-oriented by the wind such that the circular portion 87 is confronting the wind. Embodiment (B) employing an airfoil cross-section provides many advantages to the tower design that are not attainable to conventional towers.

The value of angle α may be between 30° and 60° to provide an efficient air foil shaped cross-section. Specific locations with specific prevailing wind conditions may favor a tower cross-section design wherein α is closer to 30° while other installations might be more efficient with a tower cross-section design closer to 60°. This feature gives the tower design engineer another design variable to consider and take advantage of.

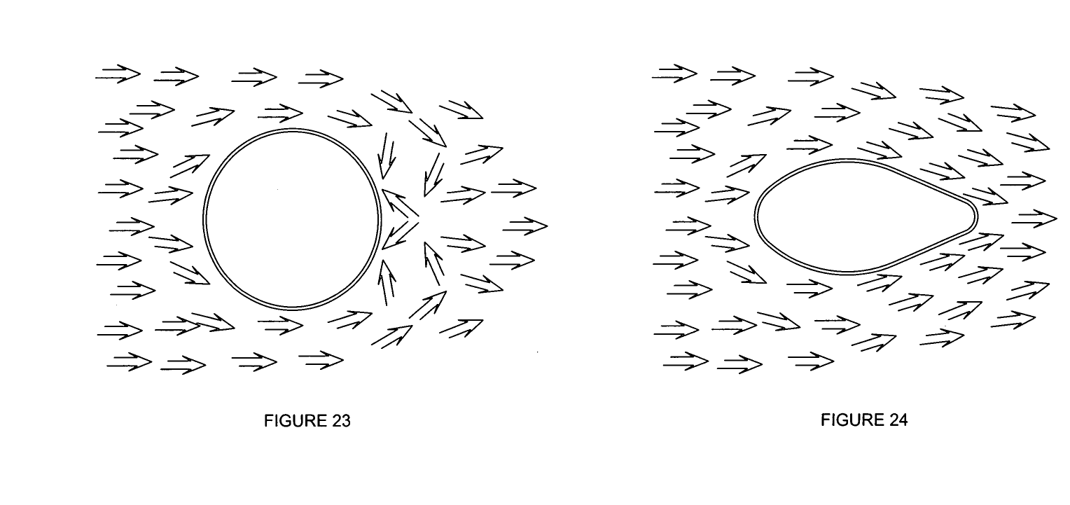

FIG. 23 shows the effect of wind streams confronting a conventional round tower structure. The arrows depict that the wind passes around to the back of the tower where continuous turbulence is created. This turbulence causes problems for down-stream adjacent turbines in a wind farm casing them to be spaced further apart than would have been necessary without the presence of this turbulence. The turbulence also causes stresses in the tower structure that result in stronger than necessary tower design if the turbulence were not present.

FIG. 24 shows the airfoil tower cross-section shown in FIG. 22 (B) and shows how the wind stream confronts this tower cross-section geometry. The airfoil design allows for smooth passage of the wind stream around the tower structure without creating turbulence on the backside of the tower.

What is claimed is:

1. A wind turbine system to generate electricity from wind energy, comprising at least the following subsystems, in functional combination:
a tower to provide the necessary altitude for favorable wind velocities, wherein the tower has an aerodynamically optimized elongated shape, such as but not limited to an airfoil shape, in order to: a) minimize the wind force against the tower when it is oriented with its elongated dimension generally parallel to the wind, b) yaw the tower into said wind parallel orientation, and c) minimize disruption to the air flow upwind and downwind from the tower, in order to reduce fluctuating forces on the turbine blades on the upwind side and to reduce turbulence that can be deleterious to other turbines on the downwind side;
a nacelle attached to the tower, substantially near to or at the top of the tower, said nacelle fixedly attached to the top of the tower;
a rotor hub attached to the nacelle;
a rotor rotatable around a substantially horizontal rotor axis of rotation and comprising a rotor hub and at least one rotor blade, said blade attached at or near its root to the rotor hub;
a first transmission located in the nacelle, connected at its input side to the horizontal turbine rotor shaft and connected at its output side to a vertical shaft running down the tower;
a generator and an optional second transmission, both located at or substantially near the bottom of the tower;
a substantially vertical shaft connecting the first and the second transmission, wherein the shaft is made of multiple shaft sections joined together with couplings that can be easily realigned and calibrated by calibration personnel to ensure a vibration-free and oscillation-free behavior;
a set of sensors mounted on or near the vertical shaft to monitor its vibration and oscillation behavior and report status at the point of the problem (at the shaft), in the machine house and/or at a remote location;
a machine house located substantially near the bottom of the tower, which contains the generator and the optional second transmission; and
a yawing mechanism located substantially near the bottom of the tower, wherein said yawing mechanism can cause the rotation of the tower around a vertical axis.

2. System and tower of claim 1, wherein the cross-section of the tower is shaped like a tear-drop, airfoil or similar aerodynamically favorable shape with the thick portion facing the wind and two convergent side-walls defined by angle.

3. System tower of claim 1, wherein the cross-section of the tower is shaped substantially like a circle (which would not provide aerodynamic advantages but may be advantageous in some cases for cost or other reasons).

4. System and tower of claim 1, wherein the tower is made of two tower sections rotatably mounted with respect to each other and with the yawing mechanism relocated appropriately close to the joint between the tower sections.

5. System of claim 1, wherein the nacelle can be rotated around the tower by a yawing mechanism, while the tower remains stationary.

6. System of claim 1, wherein the multiplication of the ratio of the first transmission by the ratio of the second transmission equals a total transmission ratio of approximately 1:100 to 1:130.

7. System and first transmission of claim 1, wherein the first transmission located at the top of the tower has a low ratio typically between 1:1 to 1:5 with the primary purpose to reduce the torque transferred to the vertical shaft and therefore reduce its weight and size, while the second transmission located in the machine house has a relatively high ratio typically between 1:15 to 1:30 with the primary purpose to increase the speed of its output shaft and provide the necessary high rotational speed to the generator.

8. System and generator from claim 1 wherein an auxiliary power system is provided that can yaw the tower or the nacelle even when the wind is low or absent and even when the grid is down, in order to ensure that under any circumstance it will be possible to safely position the turbine.

9. System of claim 1, wherein the generator in the machine house is of the direct-drive type, which does not require a transmission, effectively eliminating the need for the second transmission.

10. System of claim 1, wherein the generator in the machine house is coaxial with the vertical shaft.

11. System of claim 1, wherein the generator in the machine house is not coaxial with the vertical shaft.

12. System of claim 1, wherein the transmission in the machine house is coaxial with the vertical shaft.

13. System of claim 1, wherein the transmission in the machine house is not coaxial with the vertical shaft.

14. System and tools of claim 1, wherein a portable hydraulic ram device is utilized to apply an offset shift between two lengths of the vertical shaft to properly align the shaft.

15. System and sensor set of claim 1, wherein a laser or proximity sensor, or a contact sensor is spaced at frequent intervals along the shaft for monitoring the shaft alignment.

16. System of and vertical shaft of claim 1, wherein the couplings allow for some degree amount of misalignment, such as offset couplings or geared couplings.

17. System of and vertical shaft of claim 1, wherein the vertical shaft is shaped like a hollow tube.

18. A monitoring and reporting system that informs and warns about conditions in the vertical shaft, at the shaft level, at the machine house level and a remote monitoring facility.

19. System of claim 1 adapted for off-shore or near-shore usage wherein an elevated platform supports the tower turbine components. Said platform is located above storm surges, tidal flooding, and/or high water levels.
